(19) United States
(12) Patent Application Publication
(10) Pub. No.: US 2009/0311486 A1
(43) Pub. Date: Dec. 17, 2009

(54) OPTICAL SHEETS

(75) Inventors: Hyun Jin Kim, Yongin-si (KR); Hyun Jeong Kim, Jeju-si (KR); Jong Min Park, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: KOLON INDUSTRIES, INC., Gwacheon-si (KR)

(21) Appl. No.: 12/519,699

(22) PCT Filed: Dec. 18, 2007
(86) PCT No.: PCT/KR2007/006632

§ 371 Date: Jun. 17, 2009

(30) Foreign Application Priority Data
Dec. 18, 2006 (KR) 10-2006-0129217
Dec. 18, 2007 (KR) 10-2007-0132938

(51) Int. Cl. B32B 3/00

(52) U.S. Cl. 428/172

(57) ABSTRACT

Disclosed is an optical sheet having an optical structure, such as a prism film or sheet, which is a constituent of a backlight unit. In the optical sheet, protrusions are formed on the optical structure layer, and thus light-collecting efficiency in a front direction is maintained, and a function of diffusing light to the front or the inclined surface is also exhibited, thus eliminating the need to additionally mount a diffusion film or a protection film, thereby obviating the use of a plurality of optical films, consequently making it possible to economically manufacture a backlight unit with improved productivity.

### TECHNICAL FIELD

The present invention relates to an optical sheet, which is used for liquid crystal displays (LCDs), such as monitors, PDAs (Personal Digital Assistants), notebook computers, LCD TVs, computers, word processors, and mobile phones, in order to increase brightness.

### BACKGROUND ART

With the development of the present industrial society toward an advanced information age, the importance of electronic displays as a medium for transferring various pieces of information is increasing day by day. Accordingly, industries related to various types of flat displays, including LCDs, PDPs, and organic ELs, are prospering. In particular, an LCD, which plays a leading role in the growth of the flat display industry, is a technologically intensive product resulting from the combination of liquid crystal-semiconductor techniques, and is advantageous because it is thinner and lighter and has lower consumption power compared to other kinds of displays. Thus, the LCD may be applied not only to notebook computers, monitors, and small appliances (PDAs and mobile phones), but also to TVs, which have been regarded as the exclusive field of CRTs, which are conventional Braun tube type displays, whereby it is receiving attention as a novel display able to substitute for Braun Tube type displays, which have become a synonym for displays.

Because the liquid crystals of the LCD do not function to directly emit light, an additional light source is provided at the back surface thereof so as to display light emitted through the liquid crystals. Such a light-emitting device is called a backlight unit (BLU), which is typically composed of a cold cathode fluorescent lamp (CCFL), serving as a light source, and assistant means, including a light guide plate (LGP), a light diffusion plate, and a prism sheet, which are sequentially arranged from the light source. The light guide plate functions to actually convert an irregular linear light source, emitted from the CCFL, to the front. The light diffusion film or sheet functions to diffuse light guided to the front into surface light, and light thus diffused is collected in a direction perpendicular to the screen by the prism film or sheet, thereby increasing the front brightness of the screen, resulting in a brighter and clear image.

That is, light that is radially emitted from the lamp but may be lost is guided to the front of the screen using the light guide plate, and furthermore, light that is lost to the back surface of the screen may be re-used using a reflection film or sheet (hereinafter, referred to as a “reflection plate”). However, the light guided to the front through the reflection plate and the light guide plate has non-uniform brightness over the entire surface, and thus, it is guided to form uniform surface light using the light diffusion film or sheet. Further, the light passed through the light diffusion film or sheet is diffused again, and thus, the brightness of the front of the display is decreased. Hence, the case where an image is seen in a direction perpendicular to the screen of the display results in decreased front brightness. Accordingly, with the goal of increasing the front brightness, light transmittance to the front of the screen is increased. To this end, a film or sheet using a prism structure disclosed in U.S. Pat. Nos. 2,248,638 and 4,497,860 is applied, thereby increasing the front brightness. It has been verified that, when the film having a prism structure is used in twos such that two films are orthogonally arranged or are oriented at a predetermined angle, front light-collecting efficiency is increased (U.S. Pat. No. 4,542,449) compared to when used individually. At present, one film having a prism structure may be used, or alternatively, two films having a prism structure may be used in a state of being orthogonally arranged.

This film is manufactured by forming a roll or large-area sheet having a prism structure using transparent curable resin on a transparent film of polyester or polycarbonate, after which the sheet thus formed is cut to the size and shape required for mounting to an actual device, and then one film thus cut may be mounted to the backlight unit frame of an LCD, or two films may be orthogonally arranged and mounted thereto.

Moreover, a light diffusion film is mounted under the prism film to uniformly diffuse light directed upward through the light guide plate or the light diffusion plate, and a light-diffusing protection film is mounted on the prism film to prevent damage to the ridges of the prisms due to friction and damage to a lower polarizer film of a liquid crystal module, which is to be positioned on the backlight unit.

However, the device thus manufactured suffers because three different types of optical films are used during the manufacturing process, undesirably increasing costs and decreasing efficiency. Further, in the process of assembling the optical films of the backlight unit, the protection film and the prism film may be defective, undesirably decreasing overall material efficiency.

### DISCLOSURE

### Technical Problem

Accordingly, the present invention provides an optical sheet, in which protrusions are formed on the surface of an optical structure, and thus light-collecting efficiency is maintained, and simultaneously, light is diffused, thereby realizing the function of a diffusion film.

In addition, the present invention provides an optical sheet, which includes a particle dispersion layer having protruding particles on the surface opposite the surface having an optical structure layer, and thus the contact area between the layered devices or between the layered prism films in the course of assembling the prism films is decreased by the protruding particles, thereby decreasing damage to the surface of the non-structural layer during separation into respective films or transport.

In addition, the present invention provides an optical sheet, which includes a particle dispersion layer having protruding particles on the surface opposite the surface having an optical structure layer, and thus, when a plurality of prism films is orthogonally arranged and layered in a backlight unit, the ridges of the prisms are brought into contact with the protruding particles, thereby decreasing the contact area between the prism films and inducing a cushioning function of the particles, consequently decreasing damage to the ridges of the prism films and damage to the surface of the non-structural layer.

In addition, the present invention provides an optical sheet, which includes a particle dispersion layer having protruding particles and containing an antistatic agent on the surface opposite the surface having an optical structure layer, thus eliminating the generation of static electricity due to friction, thereby preventing image quality from deteriorating due to the attachment of impurities.

### Technical Solution

According to the present invention, there is provided an optical sheet, in which protrusions are formed on the surface of an optical structure, and thus light-collecting efficiency is maintained, and simultaneously, light is diffused, thereby realizing the function of a diffusion film.

In addition, according to the present invention, there is provided an optical sheet, which includes a particle dispersion layer having protruding particles on the surface opposite the surface having an optical structure layer, and thus the contact area between the layered devices or between the layered prism films in the course of assembling the prism films is decreased by the protruding particles, thereby decreasing damage to the surface of the non-structural layer during separation into respective films or transport.

In addition, according to the present invention, there is provided an optical sheet, which includes a particle dispersion layer having protruding particles on the surface opposite the surface having an optical structure layer, and thus, when a plurality of prism films is orthogonally arranged and layered in a backlight unit, the ridges of the prisms are brought into contact with the protruding particles, thereby decreasing the contact area between the prism films and inducing a cushioning function of the particles, consequently decreasing damage to the ridges of the prism films and damage to the surface of the non-structural layer.

In addition, according to the present invention, there is provided an optical sheet, which includes a particle dispersion layer having protruding particles and containing an antistatic agent on the surface opposite the surface having an optical structure layer, thus eliminating the generation of static electricity due to friction, thereby preventing image quality from deteriorating due to the attachment of impurities.

### ADVANTAGEOUS EFFECTS

In the optical sheet according to the present invention, protrusions are formed on a light-collecting optical structure, such as a prism, thus realizing not only a function of collecting light to the front but also a function of diffusing light to the front or the inclined surface. Thereby, there is no need to additionally mount a diffusion film.

Further, protrusions are formed on the light-collecting optical structure, such as a prism, thereby eliminating the need to additionally mount a protection film.

Furthermore, in the case where a particle dispersion layer is formed on the surface of the optical sheet opposite the surface having a light-collecting optical structure layer including prisms, damage due to friction to the prism films or other sheets can be prevented.

Hence, the use of a plurality of optical films is obviated, thus making it possible to economically manufacture a backlight unit with improved productivity.

### DESCRIPTION OF DRAWINGS

FIG. 1 is a cross-sectional view illustrating an optical film according to a first embodiment of the present invention;

FIG. 2 is a schematic view illustrating the light-diffusing mechanism of the optical film according to the present invention;

FIG. 3 is a cross-sectional view illustrating an optical film according to a second embodiment of the present invention; and

FIG. 4 is a cross-sectional view illustrating an optical film according to a third embodiment of the present invention.

### DESCRIPTION OF THE REFERENCE NUMERALS IN THE DRAWINGS

100: transparent substrate
200: optical structure layer
210: optical structure
211: protrusions
211a: particles
300: particle dispersion layer
301: particles

### BEST MODE

Hereinafter, a detailed description will be given of the present invention.

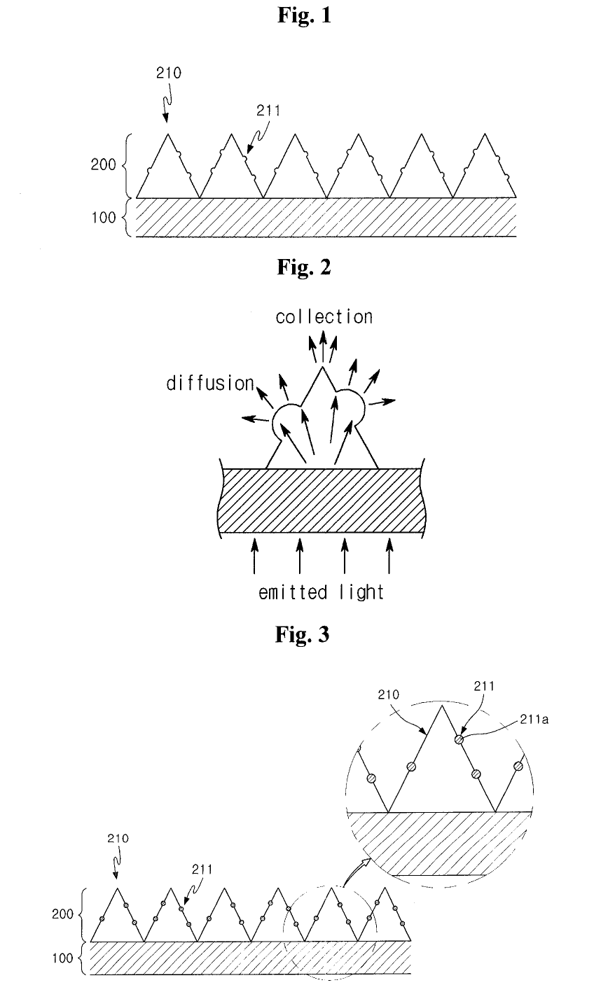

The present invention is directed to an optical sheet, such as a prism film, for use in a backlight unit of an LCD. A cross-sectional view thereof is illustrated in FIG. 1.

With reference to FIG. 1, the prism film of the present invention, that is, the film including an optical structure layer 200, has a construction in which protrusions 211 are formed on the surface of an optical structure 210.

The protrusions 211 may be formed in the range from the peak of the optical structure 210 to the valley thereof. In consideration of light-collecting efficiency, the case where the protrusions are not formed in the vicinity of the peak of the optical structure is favorable. On the other hand, in consideration of light diffusivity, the protrusions may be formed near the peak of the optical structure.

Although the shape of the protrusions 211 is not particularly limited, the cross-section thereof preferably has a semicircular shape in the interests of ease of formation of protrusions and light diffusivity.

The dimension of the protrusions may vary depending on the size of the optical structure and the required light diffusivity, and preferably has a height corresponding to 0.1˜50% of the height of the optical structure. In consideration of light-collecting efficiency, it is further preferred that the protrusions be formed to have a height corresponding to 4˜20% of the height of the optical structure.

Only the unit portion of the optical structure according to the present invention is schematically illustrated in FIG. 2. This drawing shows the traveling directions of light through the optical film of the present invention. The emitted light is collected by the optical structure 210. This is the same as the light-collecting effect of a film having a typical optical structure. Moreover, the optical structure of the present invention includes the protrusions 211, thereby realizing the diffusion of light.

The diffusion of light has a concealment effect, and thus a diffusion film, which is typically additionally provided to hide the optical structure, may be omitted.

That is, while the optical structure functions to collect light emitted from the lower portion of the substrate in a front direction, the protrusions thereof are responsible for diffusing light emitted from the lower portion of the transparent substrate to the front or the inclined surface. Thanks to such double functions, a film in which the functions of a prism and a diffusion film are combined may be provided.

The contact area may be decreased due to the protrusions, and thereby a protection film, which is conventionally used to protect the prism film, may be omitted, resulting in decreased costs and increased efficiency.

Although the process of forming such protrusions is not particularly limited, it includes, for example, forming organic or inorganic particles on the surface of the optical structure so that they protrude from the surface thereof.

A cross-sectional view of such an optical sheet is illustrated in FIG. 3. With reference to FIG. 3, the protrusions 211 formed on the optical structures 210 constituting an optical structure layer 200 may be embodied as protruding particles 211a. This may be easily confirmed from the enlarged view of FIG. 3.

As such, the particles may be inorganic or organic particles, and examples of the organic particles include acrylic particles, including methyl methacrylate, acrylic acid, methacrylic acid, hydroxyethyl methacrylate, hydroxypropyl methacrylate, acrylamide, methylolacrylamide, glycidyl methacrylate, ethyl acrylate, isobutyl acrylate, n-butyl acrylate, and 2-ethylhexyl acrylate polymers, olefinic particles, including polyethylene, polystyrene, and polypropylene, and multilayer multicomponent particles obtained by forming particles of acryl-olefin copolymers or homopolymers and then covering them with another type of monomer. In addition, inorganic particles, including silicon oxide, aluminum oxide, titanium oxide, zirconium oxide, or magnesium, may be used.

The protrusions may be formed on the optical structure using the organic or inorganic particles, and the size thereof may vary depending on the thickness and structure of the coating film, in particular, on the shape of the optical structure. The size of the particles, which is taken with respect to the long diameter of the particles, should not exceed the height of a single optical structure or the width of the bottom side thereof. Specifically, the size of the particles is 0.1˜100 μm. If the size of the particles is too large, the protruding portions thereof are very high, undesirably damaging the ridge of the optical structure.

In the optical structure, the organic or inorganic particles are preferably used in an amount of 0.1˜100 parts by weight, based on 100 parts by weight of the curable resin, from the point of view of inducing the diffusion of light.

In addition, an alternative to the process of forming the protrusions on the optical structure includes forming recesses, corresponding to desired protrusions, in means for realizing a pattern, for example, a roll for directly realizing a pattern or a resin mold for indirectly realizing a pattern, and then realizing the pattern using such means, thereby forming the protrusions on the surface of the optical structure.

In this case, light diffusivity is slightly decreased, and light-collecting efficiency may be increased, with the use of the same curable resin composition, compared to when the protrusions are formed using the particles. That is, the haze is slightly decreased and the brightness may be improved.

Thus, in consideration of the light diffusivity or light-collecting efficiency required for the optical sheet, the process of forming the protrusions may be selectively applied.

The plurality of optical structures constituting the optical structural layer may be a typical triangular prism structure, that is, a column shape having a triangular cross-section. In addition, the optical structure may have a column shape having a polygonal cross-section, a semicircular cross-section, or a semi-elliptical cross-section, or may have a triangular pyramidal shape, a tetrahedral shape, a conical shape, or a microlens shape. In particular, in terms of light-collecting efficiency to the front of the screen, it is preferred that the optical structure be a triangular prism structure.

For a transparent substrate 100 on which the optical structure layer is formed, any substrate may be used as long as it is transparent, and examples thereof include polycarbonate, polypropylene, polyethyleneterephthalate, polyethylene, polystyrene, and epoxy. Particularly useful is polycarbonate or polyethyleneterephthalate. Such a plastic substrate should have force of adhesion to the resin that is to be applied thereto, should have high light transmittance, so as not to affect the light diffusion layer, and should have uniform surface smoothness, so as not to exhibit brightness variation. The thickness of the plastic substrate ranges from 10 μm to 1000 μm, and preferably 25 μm to 500 μm.

On the transparent plastic substrate, the optical structures having surface protrusions as above are formed using a transparent curable resin having a higher refractive index than the plastic substrate, in order to increase the front brightness.

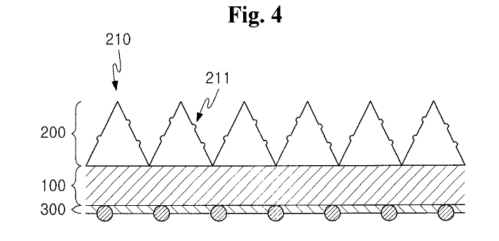

In the present invention, the optical film having the optical structure layer may further include a particle dispersion layer on the surface of the transparent substrate, opposite the surface on which the optical structure layer is formed. A cross-sectional view thereof is illustrated in FIG. 4.

With reference to FIG. 4, the particle dispersion layer 300 is composed of a transparent organic binder and organic or inorganic particles. The particle dispersion layer is formed of resin, which has high adhesiveness to the plastic substrate and high compatibility with the particles, and specific examples of such resin include acrylic resins, including unsaturated polyester, methyl methacrylate, ethyl methacrylate, isobutyl methacrylate, n-butyl methacrylate, n-butyl methyl methacrylate, acrylic acid, methacrylic acid, hydroxyethyl methacrylate, hydroxypropyl methacrylate, hydroxyethyl acrylate, acrylamide, methylolacrylamide, glycidyl methacrylate, ethyl acrylate, isobutyl acrylate, n-butyl acrylate, and 2-ethylhexyl acrylate polymers, copolymers or terpolymers, urethane-based resins, epoxy-based resins, or melamine-based resins. In order to increase heat resistance, wear resistance, and adhesiveness, a curing agent may be used to thus solidify the film of the resin.

The particles used in the preparation of the particle dispersion layer include various organic and inorganic particles. Typical examples of the organic particles include acrylic particles, including methyl methacrylate, acrylic acid, methacrylic acid, hydroxyethyl methacrylate, hydroxypropyl methacrylate, acrylamide, methylolacrylamide, glycidyl methacrylate, ethyl acrylate, isobutyl acrylate, n-butyl acrylate, and 2-ethylhexyl acrylate polymers, olefinic particles, including polyethylene, polystyrene, or polypropylene, and multilayer multicomponent particles obtained by forming particles of acryl-olefin copolymers or homopolymers and then covering them with another type of monomer. In addition, inorganic particles, including silicon oxide, aluminum oxide, titanium oxide, zirconium oxide, or magnesium fluoride, are exemplary.

The size of the particles used for the particle dispersion layer varies depending on the thickness of the coating film, but is preferably set to 0.1˜20 μm. If the particles have a large size, the protruding portion thereof is too high, and thus the ridge of the optical structure may be damaged. Preferably, the particles have a size of 0.1˜10 μm.

When the particle dispersion layer is formed, the particles are used in an amount of 0.1˜100 parts by weight, based on 100 parts by weight of the organic binder. If the amount of particles is large, in the case of organic particles, light may be diffused, or, in the case of inorganic particles, light may be reflected from the surface of the particles, undesirably decreasing light efficiency. Thus, the particles are preferably used in an amount of 1˜50 parts by weight.

In the case where portions of respective particles that protrude from the surface of the particle dispersion layer are proportionally relatively large, the ridges of the prisms may be damaged by the protruding particles. Thus, the particles should protrude such that the height of the protruding portions thereof does not exceed 50% of the particle diameter.

In addition to the particles, the particle dispersion layer may further include an antistatic agent for imparting contamination resistance to prevent the generation of dust or impurities during the manufacture of the backlight unit. The antistatic agent includes, for example, quaternary amine-, anion-, cation-, nonion-, or fluoride-based materials.

On one surface of the substrate film, formed of transparent plastic, the structure able to collect and diffuse light is formed using transparent curable resin (which includes particles, as necessary), and on the other surface thereof, the particle dispersion layer, composed of a transparent organic binder and organic or inorganic particles, is provided, thereby manufacturing an optical prism film resistant to damage from impacts, vibration, and handling.

When the film including the optical structure layer thus obtained is used for a backlight unit, the use of at least two films in a layered state is preferable.

When two optical films are layered, the protruding particles 301 of the particle dispersion layer 300 of the upper optical film are brought into contact with the optical structure layer 200 having surface protrusions of the lower optical film, and thus the contact area between the optical films is decreased, thereby preventing damage to the surface of the non-structural layer during separation into respective films or transport. Further, because the ridges of the optical structure layer are brought into contact with the protruding particles of the particle dispersion layer, the contact area between the optical films is decreased and the cushioning function of the particles is realized, thereby decreasing damage to the optical structure of the optical film and damage to the surface of the non-structural layer.

Furthermore, the protrusions are formed on the surface of the optical structure, thereby realizing the diffusion function. Therefore, there is no need to additionally mount a diffusion film.

Upon use of the films in a layered state or handling, the particle dispersion layer functions to prevent the optical structure or the surface of the film or sheet from being damaged due to impacts, vibration, and friction.

In FIGS. 1 to 4, the embodiments of the present invention are illustrated, but the invention is not limited to the number or shape of the protrusions, to the number or shape of the particles in the optical structure shown therein, and/or to the number or shape of the particles in the particle dispersion layer shown therein.

### MODE FOR INVENTION

A better understanding of the present invention may be obtained through the following examples, which are set forth to illustrate, but are not to be construed as the limit of the present invention.

### Example 1

90 parts by weight of acrylic polyol and 10 parts by weight of isocyanate were dissolved in 200 parts by weight of a methylethylketone solvent and 100 parts by weight of a toluene solvent, after which 10 parts by weight of PMMA particles (5 μm monodispersed particles) and 2 parts by weight of a quaternary amine-based antistatic agent were dispersed therein, thus preparing a solution for a particle dispersion layer.

The solution thus prepared was applied on one surface of a polyethyleneterephthalate (PET) substrate film (125 μm) using a gravure coater, and was then dried at 100° C. for 30 sec, thus manufacturing a film having a particle dispersion layer having a thickness of 6 μm, in which the thickness of the resin alone, having no particles, was 4 μm.

Thereafter, a mixture comprising 70 parts by weight of a UV curable acrylic resin, 5 parts by weight of a photoinitiator, and 25 parts by weight of PMMA particles having a particle size of 5 μm was applied on the other surface of the PET substrate film, and was then exposed to UV light, thus forming an optical structure layer including prism-shaped optical structures, having ridge angles of 90°, prism intervals of 50 μm, and heights of 25 μm, and also having surface protrusions formed using the particles, thereby completing an optical prism sheet.

### Example 2

An optical prism sheet was manufactured in the same manner as in Example 1, with the exception that the optical structures were formed to have a conical shape.

### Example 3

An optical prism sheet was manufactured in the same manner as in Example 1, with the exception that a solution comprising 100 parts by weight of curable resin and 10 parts by weight of PMMA particles was used in the formation of the optical structure layer.

### Example 4

An optical prism sheet was manufactured in the same manner as in Example 1, with the exception that PMMA particles having a particle size of 1 μm were used in the formation of the optical structure layer.

### Example 5

An optical prism sheet was manufactured in the same manner as in Example 1, with the exception that the solution for a particle dispersion layer was applied on one surface of the PET substrate film (125 μm) using a gravure coater, and was then dried at 100° C. for 30 sec, thus manufacturing a film having a particle dispersion layer having a thickness of 5 μm, in which the thickness of the resin alone, having no particles, was 2 μm.

### Example 6

An optical prism sheet was manufactured in the same manner as in Example 1, with the exception that a solution for a particle dispersion layer, including particles having a particle size of 15 μm, was applied on one surface of the PET substrate film (125 μm) using a gravure coater, and was then dried at 100° C. for 30 sec, thus manufacturing a film having a particle dispersion layer having a thickness of 15 μm, in which the thickness of the resin alone, having no particles, was 8 μm.

### Example 7

An optical prism sheet was manufactured in the same manner as in Example 1, with the exception that a solution for a particle dispersion layer containing no antistatic agent was used.

### Example 8

An optical prism sheet was manufactured in the same manner as in Example 1, with the exception that the particle dispersion layer was not formed on the substrate film.

### Example 9

An optical prism sheet was manufactured in the same manner as in Example 1, with the exception that a mixture comprising 70 parts by weight of UV-curable acrylic resin and 5 parts by weight of a photoinitiator was applied on the other surface of the PET substrate film, and was then exposed to UV light, thus forming an optical structure layer including prism-shaped optical structures, having ridge angles of 90°, prism intervals of 50 μm, and heights of 25 μm, and also having surface protrusions formed using a roll having recesses corresponding to hemispherical protrusions having a height of 1 μm.

### Example 10

An optical prism sheet was manufactured in the same manner as in Example 1, with the exception that a mixture solution comprising 70 parts by weight of UV-curable acrylic resin and 5 parts by weight of a photoinitiator was applied on the other surface of the PET substrate film, and was then exposed to UV light, thus forming an optical structure layer including prism-shaped optical structures, having ridge angles of 90°, prism intervals of 50 μm, and heights of 25 μm, and also having surface protrusions formed using a resin mold having recesses corresponding to hemispherical protrusions having a height of 1 μm, as means for forming a pattern.

### Comparative Example 1

An optical prism sheet was manufactured in the same manner as in Example 1, with the exception that the particle dispersion layer was not formed on the substrate film, and the optical structures were formed using a prism solution without particles.

### Comparative Example 2

An optical prism sheet was manufactured in the same manner as in Example 1, with the exception that the optical structures were formed using a prism solution without particles.

### Comparative Example 3

An optical prism sheet was manufactured in the same manner as in Example 1, with the exception that the optical structures were formed using a prism solution including 25 parts by weight of silica particles having a particle size of 50 nm such that the particles did not protrude from the surface thereof.

The optical films obtained in the examples and comparative examples were measured for surface roughness, haze, brightness, surface resistivity, and number of damaged ridges of prisms. The results are shown in Table 1 below. The measurement methods thereof were as follows.

(1) Measurement of Total Light Transmittance and Haze

The haze values were compared using a haze meter, NDH2000, available from Nippon Denshoku. According to the equation of ‘haze (%)=light diffusivity/total light transmittance×100’, light diffusivity was evaluated.

(2) Brightness

On a 17 inch LM170E01 (Heesung Electronics, Korea) Model, from which ready-made prism sheets were removed, the optical sheet, manufactured as above, was placed as below, after which 13-point brightness values thereof were measured and averaged using a brightness meter, BM7 (Topcon, Japan). The optical sheet was constructed in a manner such that two respective sheets of Examples 1 to 10 were orthogonally arranged and layered, and a light guide plate was placed thereunder. (light guide plate+sheet of the example+sheet of the example).

In Comparative Examples 1 to 3, the optical sheet was composed of a light guide plate, a diffusion film, the sheet of the comparative example, and a protection film, which were sequentially layered.

(3) Surface Resistivity

The resistivity was measured using a surface resistivity meter, Keithley 238 (Keithley).

(4) Damage of Ridge of Prism

Two prism sheets were orthogonally arranged and layered, and predetermined impact was applied thereto using a vibration tester, after which the number of damaged prisms per predetermined area of 1 cm×1 cm was counted using an electron scanning microscope.

TABLE 1

| | | | Surface | No. of Damaged |
|---|---|---|---|---|
| | Haze | Brightness | Resistivity | Prism Ridges |
| | (%) | (cd/m²) | (Ω/□) | (No./cm²) |
| Criteria | — | — | 10¹² or less | No Damage |
| Ex. 1 | 50 | 2,010 | 10¹¹ | No |
| Ex. 2 | 50 | 2,008 | 10¹¹ | No |
| Ex. 3 | 30 | 2,013 | 10¹¹ | No |
| Ex. 4 | 55 | 2,010 | 10¹¹ | No |
| Ex. 5 | 50 | 2,010 | 10¹¹ | 3 |
| Ex. 6 | 50 | 2,010 | 10¹¹ | No |
| Ex. 7 | 50 | 2,010 | 10¹⁴ | No |
| Ex. 8 | 50 | 2,010 | 10¹⁴ | 5 |
| Ex. 9 | 40 | 2,014 | 10¹¹ | No |
| Ex. 10 | 40 | 2,013 | 10¹¹ | No |
| C. Ex. 1 | 5 | 2,007 | 10¹⁴ | 7 |
| C. Ex. 2 | 5 | 2,007 | 10¹¹ | No |
| C. Ex. 3 | 40 | 1,970 | 10¹¹ | No |

As is apparent from the results of Table 1, in the case of the films having the optical structure layer according to the present invention, the protrusions were formed on the surface of the optical structure of the optical structure layer, and thus, the haze thereof, as an index for evaluating light diffusivity, was improved. In the brightness test, when two films were layered without the diffusion film and the protection film, high brightness resulted. Also, these results could be seen to be almost consistent regardless of the process used to form the protrusions. In particular, in the case where the particle dispersion layer was formed, the scratching or attachment of impurities due to static electricity could be prevented during the working process, thus further decreasing damage to the ridges of the prisms. Also, the case where the antistatic agent was contained in the particle dispersion layer had more satisfactory surface resistivity, and had no damage to the ridges of the prisms when two prism films were layered. However, in the case where the particle dispersion layer was formed but the protrusions were not formed on the prism structure, the prism per se had no diffusion performance, and thus it was necessary to use a protection film. In the case where the particles were included in the prism structure but did not protrude from the surface of the structure layer, the haze of the optical film per se was increased but the diffusion of light to the surface thereof was difficult to induce, and thus it was necessary to use a light-diffusing protection film.

In the case where the protrusions were not formed on the prism structure and the particle dispersion layer was not formed, the ability to diffuse light was not exhibited. From the point of view of compensation therefor, a diffusion film was additionally layered, undesirably increasing the cost and decreasing workability. Furthermore, the ridges of the prisms were readily damaged.

1. An optical sheet, comprising a transparent substrate and an optical structure layer having a plurality of optical structures formed using a curable resin composition on a surface of the transparent substrate, wherein protrusions are formed on a surface of the optical structures.

2. The optical sheet according to claim 1, wherein a cross-section of the protrusions has a semicircular shape.

3. The optical sheet according to claim 1, wherein the protrusions have a height corresponding to 0.1-50% of a height of the optical structures.

4. The optical sheet according to claim 3, wherein the protrusions have a height corresponding to 4-20% of a height of the optical structures.

5. The optical sheet according to claim 1, wherein the protrusions are formed on the surface of the optical structures in a manner such that organic or inorganic particles protrude from the surface thereof.

6. The optical sheet according to claim 5, wherein the organic or inorganic particles have a particle size of 0.1-100 μm.

7. The optical sheet according to claim 6, wherein the organic or inorganic particles are used in an amount of 0.1-100 parts by weight, based on 100 parts by weight of the curable resin.

8. The optical sheet according to claim 1, wherein the protrusions are formed using a roll having recesses corresponding to the protrusions.

9. The optical sheet according to claim 1, wherein the protrusions are formed using a resin mold having recesses corresponding to the protrusions.

10. The optical sheet according to claim 1, wherein the optical structures have a shape selected from among a column shape having a triangular cross-section, a polygonal cross-section, a semicircular cross-section, or a semi-elliptical cross-section, a tetrahedral shape, a conical shape, and a microlens shape.

11. The optical sheet according to claim 1, wherein the optical structures have a column shape having a triangular cross-section.

12. The optical sheet according to claim 1, wherein a particle dispersion layer comprising a transparent binder and particles is formed on a surface of the transparent substrate opposite the surface having the optical structure layer, the particles of the particle dispersion layer protruding from a surface thereof.

13. The optical sheet according to claim 12, wherein the particles of the particle dispersion layer protrude such that a height of protruding portions of the particles does not exceed 50% of a particle size.

14. The optical sheet according to claim 12, wherein the particle dispersion layer further comprises an antistatic agent.

15. The optical sheet according to claim 2, wherein the protrusions have a height corresponding to 0.1-50% of a height of the optical structures.

16. The optical sheet according to claim 15, wherein the protrusions have a height corresponding to 4-20% of a height of the optical structures.

17. The optical sheet according to claim 10, wherein the optical structures have a column shape having a triangular cross-section.
